(19) United States
(12) Patent Application Publication
(10) Pub. No.: US 2016/0002465 A1
(43) Pub. Date: Jan. 7, 2016

(54) COMPOSITIONS AND METHODS FOR HOT AND WARM MIX ASPHALT CONCRETE ADDITIVES

(71) Applicant: Billy Shane McDade, Lakeway, TX (US)

(72) Inventor: Billy Shane McDade, Lakeway, TX (US)

(21) Appl. No.: 14/793,330

(22) Filed: Jul. 7, 2015

Related U.S. Application Data
(60) Provisional application No. 62/021,668, filed on Jul. 7, 2014.

(51) Int. Cl. C08L 95/00

(52) U.S. Cl. CPC C08L 95/005

(57) ABSTRACT

Disclosed herein are formulations for, and methods of making and using hot and warm mix asphalt concrete and additives in the production of asphalt to improve the quality and performance of said asphalt concrete.

### CROSS-REFERENCE TO RELATED APPLICATIONS

This application claims the benefit under Title 35 United States Code §119(e) of U.S. Provisional Patent Application Ser. No.: 62/021,668; Filed: Jul. 07, 2014, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present disclosure generally relates to formulations for, and methods of making and using hot and warm mix asphalt concrete additives. More specifically, the present invention generally relates to formulations for, and methods of making and using hot and warm mix asphalt concrete and additives in the production of asphalt to improve the production process, quality, and performance of said asphalt concrete.

### BACKGROUND OF THE INVENTION

Without limiting the scope of the disclosed formulations and methods, the background is described in connection with novel formulations and methods of making and using hot and warm mix asphalt concrete utilizing additives.

It is an object of the invention to provide alternative formulations and methods of making and using hot and warm mix asphalt concrete with improved performance and quality than conventional methods currently being used to produce asphalt concrete.

Asphalt concrete paving material, commonly referred to as asphalt, is a mixture of hot liquid asphalt binder and aggregates. In some mixtures, the asphalt also contains other additives.

Traditional asphalt concrete is made as a hot-mix asphalt. Hot mix asphalt is mixed at temperatures of around three hundred to three hundred fifty degrees Fahrenheit. The hot mix asphalt concrete is applied to roadways utilizing specialized machines, compacted, and the hot mix asphalt concrete hardens as it cools.

Hot mix asphalt concrete producers will often put an anti stripping agent additive in hot mix asphalt. These additives help the asphalt binder coat and stick to the individual aggregate particles. The prior art contains many anti stripping agents that are used as additives and many are commercially available. Lime is a known anti stripping agent.

Hot mix asphalt concrete producers realized that some of the anti stripping agents had the unexpected property of allowing the asphalt to be produced at lower temperatures of around thirty to one hundred degrees Fahrenheit below typical hot mix asphalt concrete temperatures. Producing asphalt at lower temperatures is desirable as this leads to lower cost of production and improved worker safety in having to not deal with as hot of a material. This approach to producing asphalt concrete is commonly referred to as warm mix asphalt concrete and many anti stripping additives are marketed as warm mix additives. This lower temperature production is accomplished by the additive thinning or reducing the viscosity of the asphalt binder at cooler temperatures, allowing the sufficient coating of aggregates while maintaining workability. Typical compositions of warm mix asphalt concrete is the same as for the hot mix asphalt concrete, except for the additive utilized in the warm mix applications to lower the viscosity.

Another method of producing warm mix asphalt concrete is through a water injection method. This method uses specialized equipment that can be installed on site at warm mix asphalt concrete production sites, to inject small amounts of water into the hot liquid asphalt binder. This approach causes a foaming action within the asphalt binder and allows it to coat the aggregate at lower temperatures.

Although the market of warm mix asphalt concrete is growing and currently holds about a thirty percent market share, it is still not as desirable as hot mix asphalt concrete. Some drawbacks include costs attributable to quality and transportation of the material. As an example, hot mix asphalt concrete starts out hotter allowing for further distances it can be transported.

Another drawback to warm mix asphalt concrete is that it does not achieve as high a quality when adding recycled components. Since there are large stockpiles of reclaimed asphaltic materials, hot mix asphalt concrete is often produced with a certain percentage of recyclable materials. Two of the most commonly used are reclaimed asphalt pavement (RAP) and recycled asphalt shingles (RAS). RAP is old roadways that have been milled up and RAS is old asphalt shingles from buildings or manufactured waste. The percentage of old hot mix asphalt concrete that is allowed to be from recycled materials is dependent up on the specifications of the end user such as the Department of Transportation and the County. Ten to thirty percent of recycled material is a commonly accepted range. Because the asphalt in RAP and RAS is often old and highly oxidized through the loss of light carbon elements, it must be heated to greater temperatures than a virgin binder to become liquefied and mix with the new hot mix asphalt. These higher mixing temperatures are also damaging to the virgin liquid asphalt binder in the mix. In addition, a softer virgin liquid asphalt binder is typically used in hot mix asphalts mixes that contain a recycled component to compensate for the presence of the harder, oxidized asphalt in the RAP and RAS. Despite the higher temperatures and softer binder used for hot mix asphalt cement that contains recycled materials, the quality is below hot mix asphalt concrete produced entirely from virgin materials.

Warm mix asphalt concrete utilizing warm mix additives have also attempted the incorporation of recycled materials. However, this is even more undesirable than hot mix asphalt concrete due to the lower heats involved. Hot mix asphalt concrete produced with recycled materials such as RAP and RAS are produced at much higher temperatures.

If warm mix asphalt concrete using recycled materials such as RAP and RAS could be produced with higher quality as determined by mix design characteristics, laboratory testing, and field observations, it would extremely desirable due to the less energy consumption, increasing the content of recycled components in asphalt cement concrete, reduced cost, improved safety due to lower temperature of material, and warm mix asphalt concrete may be applied in cooler temperatures to name a few.

An example of the terminology and practices in the art is disclosed in U.S. patent patent Ser. No. 8/814,464 issued to Billy Shane McDade et al. on Aug. 26, 2014 and entitled, “RECYCLED RECLAIMED ASPHALT PAVEMENT.” Another example of the art is disclosed in U.S. patent application Ser. No. 13/751,688 filed by Billy Shane McDade et al. on Jan. 28, 2013 an entitled, “COLD MIX ASPHALT AGGREGATE PAVING MATERIAL.”

What is desired, therefore, is a formulation and method of making and using hot and warm mix asphalt concrete with improved quality and performance.

The information included in this background section of the specification is included for technical reference purposes only and is not to be regarded as subject matter by which the scope of the description is to be bound or as an admission of prior art.

### BRIEF SUMMARY OF THE INVENTION

Accordingly, it is an object of the present invention to provide alternative formulations and methods of making and using hot and warm mix asphalt concrete with improved performance and quality than conventional methods currently being used to produce asphalt concrete.

In summary, the present invention discloses novel formulations/compositions and methods of making and using hot and warm mix asphalt concrete.

In an embodiment the asphalt composition is comprised of an asphalt mix and an emulsified maltene. In another embodiment, the asphalt composition is comprised of warm mix asphalt, an emulsified maltene, and an anti stripping agent. In yet another embodiment, the asphalt composition is comprised of an asphalt mix and an anti stripping agent.

In an embodiment, the method of making and using a warm mix asphalt concrete, utilizes the water or foam injection method with the water substituted by an emulsified recycling agent/rejuvenator. In another embodiment, the method of making and using a warm mix asphalt concrete, utilizes the water or foam injection method with the water substituted by an emulsified maltene. In yet another embodiment, the method of making and using a warm mix asphalt concrete, utilizes the water or foam injection method with the water substituted by an emulsified recycling agent/rejuvenator or maltene with the emulsifier also being an anti-stripping agent.

In other embodiments, the asphalt composition is comprised of a hot mix asphalt concrete and a maltene. That is, the maltene is added as part of the hot mix asphalt concrete in a non-emulsified form. The maltene is added to the virgin binder.

### DETAILED DESCRIPTION OF THE INVENTION

Disclosed herein are novel formulations for, and methods of making and using hot and warm mix asphalt concrete additives in the production of asphalt to improve the production process, quality, and performance of said asphalt concrete.

The numerous innovative teachings of the present invention will be described with particular reference to several embodiments (by way of example, and not of limitation).

Maltenes are a known asphalt rejuvenator and have been used as a fog seal surface treatment, that is, sprayed on asphalt concrete in an attempt to revive them and retard oxidation. It has also been added to asphalt emulsions as a rejuvenating agent. Please see “Engineering Mixes: A Closer Look At Rejuvenators” by Robert Lee published in Texas Asphalt Magazine in the Spring of 2014 issue. However, since the chemical structure of maltenes and other rejuvenators do not allow, by themselves, the reduction in temperature and are not known to have anti stripping properties, they have not been used as an additive in hot mix asphalt concrete or warm mix asphalt concrete produced by the water or foam injection method. By emulsifying maltenes with the appropriate percentage of water, their viscosity could be reduced and they could be used in place of water in the water injection or foaming method of producing asphalt concrete. Introducing rejuvenating agents and anti-strip agents into production warm mix asphalt cement in this way is novel to the industry.

Using emulsified maltenes instead of water to produce warm mix asphalt concrete allows for the introduction of light carbons that the maltenes consist of at the point of warm mix asphalt concrete production, which offers several advantages over traditional warm mix asphalt concrete. Some of these advantages are that reclaimed asphalt pavement and reclaimed asphalt shingles can be added to the mix at lower temperatures because the maltenes are rejuvenating the mix and not excessive heat. In addition, reclaimed asphalt pavement and reclaimed asphalt shingles can be added at a larger percentage of the overall mix. The mix is also of higher quality than traditional anti-strip warm mix asphalt concrete. Lastly, even on warm mix asphalt concrete that do not contain reclaimed asphalt pavement or reclaimed asphalt shingles, the pavement life will be extended due to the oxidation retarding effects of the maltenes.

One initial drawback that was found with the proposed method versus anti strip warm mix asphalt concrete is that the anti strip warm mix asphalt concrete is less prone to stripping. Stripping is where the asphalt binder becomes separated from the aggregates. However, certain emulsifiers are known to have anti stripping properties. By using one of these chemicals to emulsify the maltenes to obtain the maltene emulsion used as the warm mix asphalt additive, the same anti stripping properties can be achieved with the advantages mentioned previously.

In accordance with the embodiments, a method is described wherein the method of making the warm mix concrete utilizing the water or foam injection method has the water substituted by a maltene emulsification. That is, emulsified maltene is utilized as a warm mix additive. This approach may be used with all asphalt concrete mixes common to the industry. The object is to supply enough water to foam the liquid binder, along with enough rejuvenating agent to retard oxidation in the virgin binder and/or rejuvenate the oxidized asphalt in added recycled components, which may vary as a percentage of the overall asphalt concrete mix. This is accomplished by changing the ratio of water to rejuvenating agent in the emulsion (essentially diluting the emulsion). The amount of water and rejuvenating agent needed to produce a high-quality mix is determined by the mixture design, the performance of which is common to the industry and the minimum specifications of which are established by the various governing roadway authorities. A common approach would be to make a “controlled” mixture design, which contains all elements of the asphalt concrete mixture (for example, 10% RAP, 5% RAS, 5% virgin asphalt binder, and 80% virgin aggregate, or rock/sand mixture) except for the emulsified rejuvenating agent. Next, make several sets of the same mixture design except adding various contents of emulsified rejuvenator (for example, 0.05%, .05%, 1%, 1.5% and 2% emulsified rejuvenator by weight of the liquid binder, and comparing them using accepted testing methods (for example Hamburg testing, an example of which is included in this application), which will determine the amount by which addition of the emulsified rejuvenating agent has improved quality. In other iterations, the amount of virgin liquid asphalt binder may be reduced as the added rejuvenating agent allows it to be replaced with the newly rejuvenated asphalt in the added RAP and/or RAS component. The maltene emulsion is maltenes emulsified by methods known in the art and falls near the range of one or two percent by weight of emulsifier to maltenes. As an example, the maltene emulsion would have a 60-65% by weight maltene content, 30-35% by weight water content, and 0.1-5% by weight emulsifier content. In other examples the weight by maltene content may be in the range of 10-90% and the water by weight content in the range of 10-90%, with the emulsifier in the range of 0.1-10%.

Reference is now made to Table 1 wherein the results for a Hamburg Wheel Test (HWT) performed on a mixture design are presented. The first data row represents the controlled mixture design having no maltene emulsion added to the mix and having almost nineteen thousand passes. The second data row represents a maltene emulsion addition to the mix of one percent by weight of the virgin binder and having almost twenty seven thousand passes. The third data row represents a maltene emulsion addition to the mix of one point seven five percent by weight of the virgin binder and having nineteen thousand passes.

TABLE 1

| | 5K | 10K | 15K | 20K | 25K | |
|---|---|---|---|---|---|---|
| | Rut depth in | Rut depth in | Rut depth in | Rut depth in | Rut depth in | |
| Maltene | millimeters | millimeters | millimeters | millimeters | millimeters | |
| Emulsion | at 5,000 | at 10,000 | at 15,000 | at 20,000 | at 25,000 | Final |
| (%) | passes | passes | passes | passes | passes | Passes |
| 0 | 1.9 | 3.1 | 7.2 | 12.6 | | 18900 |
| 1 | 1.6 | 2.0 | 2.9 | 5.1 | 10.7 | 26700 |
| 1.75 | 1.6 | 2.6 | 7.7 | 12.7 | | 19000 |

In other embodiments, the asphalt composition is comprised of a hot mix asphalt concrete and a maltene. That is the maltene is added as part of the hot mix asphalt concrete in a non-emulsified form. The maltene is added to the virgin binder.

In brief, the invention is directed to formulations for, and methods of making and using hot and warm mix asphalt concrete additives in the production of asphalt concrete to improve the quality and performance of said asphalt concrete.

The disclosed compositions and method is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed formulations, compositions, and/or methods of use, except as may be outlined in the claims.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific systems and methods described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent applications are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The formulations, compositions, and/or methods of use disclosed and claimed herein can be made and executed without undue experimentation in light of the present disclosure. While the compositions, formulations, and methods of this invention have been described in terms of preferred embodiments, it will be apparent to those skilled in the art that variations may be applied to the formulations, compositions, and/or methods in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A warm mix asphalt concrete composition comprising:
an aggregate or rock sand mixture;
an asphalt binder; and
an emulsified recycling agent or emulsified rejuvenator.

2. The warm mix asphalt concrete composition of claim 1, wherein said emulsified recycling agent or emulsified rejuvenator is an emulsified maltene.

3. The warm mix asphalt concrete composition of claim 1, further comprising an anti-stripping agent.

4. The warm mix asphalt concrete composition of claim 2, further comprising an anti-stripping agent.

5. The warm mix asphalt concrete composition of claim 1, wherein said emulsifier has anti-stripping properties.

6. The warm mix asphalt concrete composition of claim 2, wherein said emulsifier has anti-stripping properties.

7. The warm mix asphalt concrete composition of claim 3, wherein said emulsifier has anti-stripping properties.

8. The warm mix asphalt concrete composition of claim 4, wherein said emulsifier has anti-stripping properties.

9. The warm mix asphalt concrete composition of claim 1, further comprising reclaimed asphalt pavement (RAP).

10. The warm mix asphalt concrete composition of claim 1, further comprising recycled asphalt shingles (RAS).

11. The warm mix asphalt concrete composition of claim 1, further comprising reclaimed asphalt pavement (RAP) and recycled asphalt shingles (RAS).

12. The warm mix asphalt concrete composition of claim 1, wherein said emulsified recycling agent or emulsified rejuvenator is in the range of 0.05% to 10% by weight of said asphalt binder.

13. The warm mix asphalt concrete composition of claim 2, wherein said emulsified maltene is in the range of 0.05% to 10% by weight of said asphalt binder.

14. The warm mix asphalt concrete composition of claim 3, wherein said emulsified recycling agent or emulsified rejuvenator is in the range of 0.05% to 10% by weight of said asphalt binder.

15. The warm mix asphalt concrete composition of claim 4, wherein said emulsified maltene is in the range of 0.05% to 10% by weight of said asphalt binder.

16. The warm mix asphalt concrete composition of claim 9, wherein said recycling agent or emulsified rejuvenator is in the range of 0.05% to 10% by weight of said asphalt virgin binder.

17. The warm mix asphalt concrete composition of claim 10, wherein said recycling agent or emulsified rejuvenator is in the range of 0.05% to 10% by weight of said asphalt virgin binder.

18. A hot mix asphalt concrete composition comprising:
an aggregate or rock sand mixture;
an asphalt binder; and
a recycling agent or rejuvenator.

19. The hot mix asphalt concrete composition of claim 18, wherein said recycling agent or rejuvenator is a maltene.

20. A method of making warm mix asphalt concrete comprising the steps of:
a foam or water injection method for making warm mix asphalt and substituting the water with a maltene emulsification.
